(19) United States
(12) Patent Application Publication
(10) Pub. No.: US 2008/0272916 A1
(43) Pub. Date: Nov. 6, 2008

(54) Bottle Cap and Bottle

(76) Inventors: Marc Breysse, Barcelona (ES); Felix Gonzalez Elorriaga, La Rioja (ES)

Correspondence Address: RATNERPRESTIA, P O BOX 980, VALLEY FORGE, PA, 19482-0980, US

(21) Appl. No.: 11/884,959

(22) PCT Filed: Feb. 22, 2006
(86) PCT No.: PCT/ES2006/000078

§ 371 Date: Apr. 16, 2008

(30) Foreign Application Priority Data
Feb. 24, 2005 (ES) 200500417

(51) Int. Cl. G08B 13/22; B65D 23/00

(52) U.S. Cl. 340/572.8; 215/386

(57) ABSTRACT

The invention relates to a device which can be detected wirelessly by one or more sensors in a security system when located within the coverage range thereof. The aforementioned device includes storage means for storing customized identifying data for each bottle and is designed such that data can be wirelessly read or read and written by the sensor(s) belonging to the security system and/or by other sensors that do not form part of the system. The device preferably includes an RFID label and the wireless channels are established by means of radio-frequency. According to the invention, the device is placed in the cap and is destroyed or malfunctions when the cap is opened, such that fraudulent use can be detected.

### FIELD OF THE ART

The present invention generally relates to a capsule for bottles, incorporating a device with identifying data, which can be detected and read in a wireless manner for the purpose of preventing the theft, fraudulent manipulation and/or the counterfeiting of the bottles incorporating such a type of capsule, and more particularly to a capsule for bottles with an RFID or radiofrequency identification tag.

A bottle is also proposed which can be applied to contain alcoholic beverages or liquors, comprising a capsule like the one proposed.

### PRIOR STATE OF THE ART

One of the most important challenges faced by the sector of wine, liquors and other beverages is the effective protection of its products against counterfeiters.

The brand counterfeiting market has increased dramatically in all the economy sectors (150% between 1990 and 1995), applied to several types of products.

A really worrying aspect is that 60% of counterfeit products are sold in the official channel, the beverage sector being one of the most affected.

Counterfeiting consists of imitating or copying the bottles of the most known and renowned brands, or filling empty bottles with any low-quality beverage. The process starts with the collection of empty containers by waiters or the staff of some bars and restaurants, who sell an attractive collection of bottles for a small amount of money, or by means of a coordinated action with some waste collectors. It is quite easy for these counterfeiters to fill and re-encapsulate the bottles, if it is considered that the means necessary for counterfeiting them do not involve an important investment. These counterfeiting networks devote themselves to filling authentic bottles of known brands with low-quality beverages, selling said counterfeit bottles at below their usual price, many times also in the official channel, with the subsequent damage for the brands. It is only the capsule, which usually does not have any type of identification, which in some cases could distinguish them just by looking at them though not always, because the content cannot be seen.

It is seriously damaging for the consumer, who is deceived, but it is especially damaging for the industry, the products of which lose prestige, some brands being able to lose up to 20% to 30% of their turnover due to these fraudulent practices.

Apart from the economic damage for the manufacturers, and especially the loss of reputation for the brands, it may be a health risk for the consumers because there is no control or hygiene in the counterfeiting business. These bottles are original ones and the conditions in which they are packaged and the types of product with which they are filled are not known, and this aspect may represent a serious hazard for public health.

Most brands attempt to protect themselves against this important fraud and some of them even invest 3 to 5% of their turnover both in anti-counterfeiting systems and components and in undertaking legal actions.

Some security elements are the tags and seals surrounding both the bottle and the bottle neck. They can incorporate different security elements: security bottoms, encoded printing, iridescent printing, rosettes, anti-scanner and anti-photocopy colors, neutral response to ultraviolet light, luminescent fibers and ink that is only visible by means of its exposure to ultraviolet light, latent image, microtext, phosphorescent inks . . . or DNA print (This DNA coding allows certifying the authenticity of high price products).

One of the drawbacks of security tags is that they do not easily prevent the products from being counterfeited because they can be reproduced quite faithfully, without the consumer being able to detect the fraud or due to the fact that the original tags can be easily removed although special glues are used to stick them.

In the wine sector, the producers attempt to introduce new security elements, corks with special seals, laser etching in the glass of the bottles.

But in spite of the different existing anti-counterfeiting alternatives, none of them allows the final user to recognize the quality and originality of the product easily, reliably, safely and without depending on third parties. For example, the use of an advanced hand scanner is necessary in the case of DNA prints.

The aforementioned systems also do not allow identifying if an authentic bottle has been stolen or deviated from the market to which it was directed, or recognizing if a false bottle is being distributed through the official channel.

It is therefore necessary to have a really effective system that can assure that each bottle leaving the production chain is duly identified in a unique and singular manner, and that each product which has been distributed in warehouses, stores and restaurants is authentic and has not been manipulated, allowing the final user to recognize the quality and authenticity of the product easily, reliably and safely, without depending on third parties.

This system should further ensure that it is impossible to reuse at least one of the original components, starting from the time at which the bottle has been opened, in order to prevent its counterfeiting.

In addition, the proposal provided by patent document WO-A-0175254 proposes a security device for bottles with the possibility of incorporating a responder acting by radiofrequency, which can be incorporated inside a cap to be coupled to the bottle. Nevertheless, the only objective of said responder is to detect if the bottle leaves a perimeter monitored by a security system, i.e., to prevent it from being stolen, but not the personalized identification of each of the bottles.

### DESCRIPTION OF THE INVENTION

It therefore seems to be necessary to cover the gaps in the state of the art relating not only to security against the theft of the bottles but also against their manipulation for the purpose of counterfeiting such bottles and/or their content.

To that end, in a first aspect the present invention relates to the different types of capsule or capsules that are incorporated in the bottles, of the type comprising a device suitable for being detected through a wireless route by one or more sensors of a security system, when it is located within its coverage range.

Said device, which can be passive or active, comprises storage means for storing identifying data and is adapted to allow at least their reading, also through a wireless route, by said sensor or sensors of said security system and/or by other sensors that do not form part of said security system.

Said wireless route allowing said detection and/or said wireless route allowing said reading are generally set up by means of radiofrequency, although other technologies which a person skilled in the art may think of are also possible, such as infrared technology, etc.

For one embodiment, the device is a laminar element, preferably a radiofrequency identification tag, or RFID tag.

As regards the mentioned identifying data, these comprise information which can be treated and managed by a control system associated to said sensors suitable for reading said identifying data, and to a database for managing and/or following and/or controlling the production and the distribution of said bottles.

For one embodiment, said identifying data include information relating to for example, name, year, winery, date of bottling, etc. of the liquid contained in the bottle to which said capsule belongs.

For another embodiment, the identifying data are only references to other corresponding data registered in said database, which are those that really include the characteristics of the product. For the latter case, storage means with a large storing capacity are not necessary because it is enough for each device to store a single reference.

Other preferred embodiments of the invention are defined in the dependent claims, as well as in the following description of several embodiments.

A second aspect of the present invention relates to a bottle which can be applied to contain an alcoholic beverage or liquor, comprising a capsule according to the first aspect of the present invention in any of its embodiments.

### BRIEF DESCRIPTION OF THE DRAWINGS

Other features of the invention will be more clearly understood from the following description of several embodiments shown in the attached drawings and which must be considered as illustrative and non-limiting. In the drawings:

FIGS. 1 and 2 are two elevational views of the capsule proposed for two embodiments for which the proposed device is placed in two different outer areas of the capsule,

FIGS. 3 and 4 are two sectioned elevational views of two other embodiments in which the device is placed in two different inner areas of the capsule,

FIG. 5 shows another further embodiment by means of an elevational view of the capsule for another arrangement of the proposed device,

FIGS. 6 to 8 show, by means of perspective views, three other embodiments depicting different versions of the proposed device,

FIG. 9 shows a perspective view of part of a bottle incorporating the proposed capsule, which is depicted in an opening position, and

FIG. 10 also shows a perspective view of part of the body of a bottle with the proposed capsule, the device of which is being examined by an external device in a wireless manner.

### DETAILED DESCRIPTION OF SEVERAL EMBODIMENTS

As shown in the figures, the bottle capsule comprises a flap 1 with different shapes and sizes wrapping the bottle neck and an upper part 2 covering the end of the bottle neck. According to the invention, for the embodiments shown the proposed device is a radiofrequency identification element or RFID tag, microchip or the like 3.

The aforementioned sensors suitable for reading the identifying data of the RFID tag 3 are or form part of, for example, an RFID reader, a mobile telephone, a personal digital assistant (PDA) or the like 7 with an integrated or external RFID reading module, with the capacity of being connected directly to the reader or by means of wireless connection. FIG. 10 shows one of said readers 7 in wireless communication with the RFID tag 3 of a capsule 1.

Additionally, for another embodiment, the present invention also contemplates that the RFID device or tag 3 is adapted to allow writing data in said storage means, also through a wireless route.

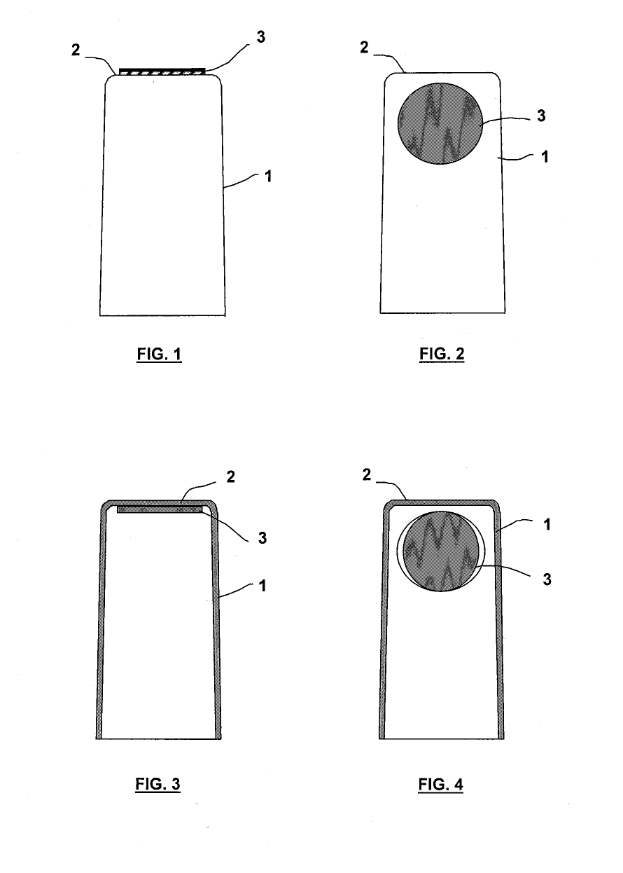

For the embodiment shown by FIGS. 1 and 2, the RFID tag 3 is placed in the outer part of the capsule, on said upper part 2 of the capsule and on said flap 1 respectively.

FIGS. 3 and 4 show other embodiments for which the RFID tag is placed in the inner part of the capsule, under the upper part 2 of the capsule and under the flap 1 respectively.

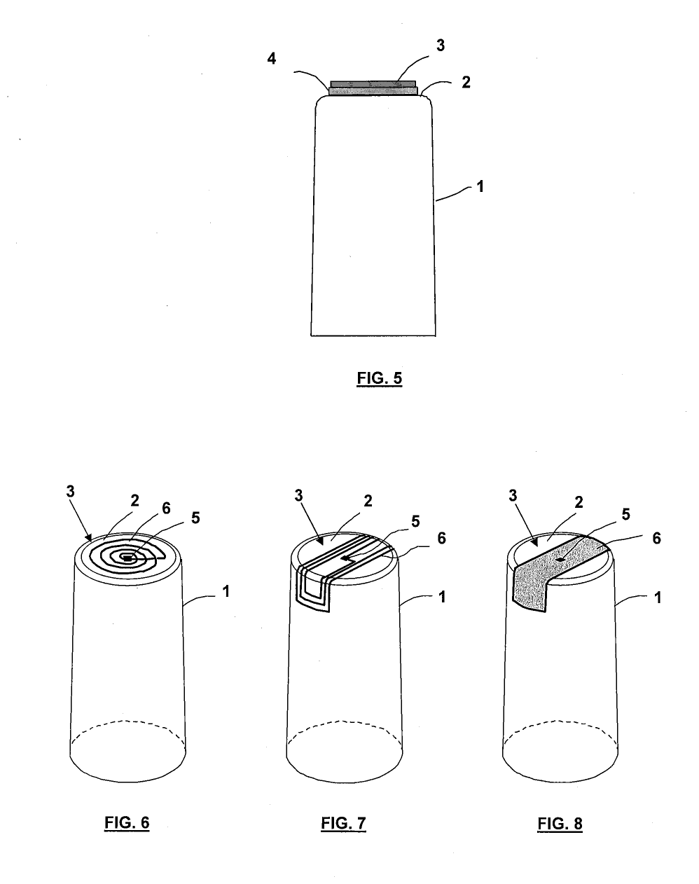

In the presence of metal, in the event that the capsule is made of metal, important interferences due to magnetic fields could occur, which interferences prevent reading the information of the RFID tag 3 or significantly reduce the distance for reading said RFID tag. For the purpose of minimizing and reducing the negative effect of such possible magnetic interferences on the RFID tag 3, such tag comprises suitable insulation means, which means comprise, for the embodiment shown in FIG. 5, a separating element 4, made of an insulating material against magnetic interferences, such as ferrite, arranged between the RFID tag 3 and the part of the capsule in which it is placed (between the RFID tag 3 and the upper part 2 of the capsule in said figure).

For another embodiment (not shown) said insulation means comprise a film, made of an insulating material against magnetic interferences, covering at least part of the capsule.

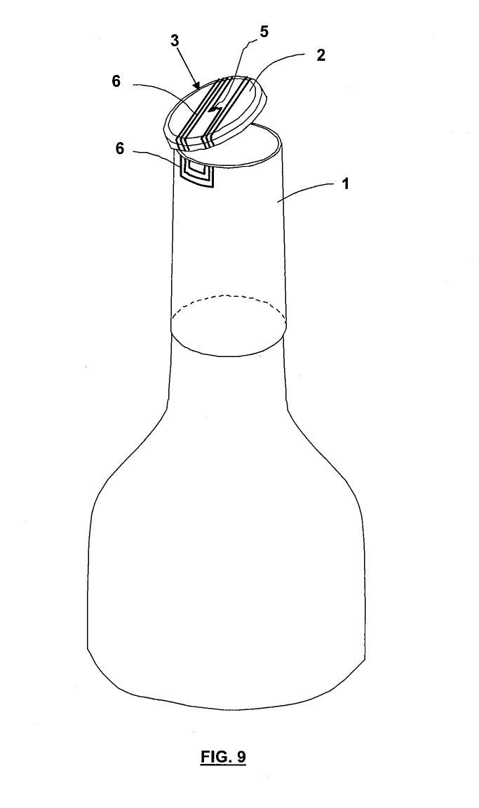

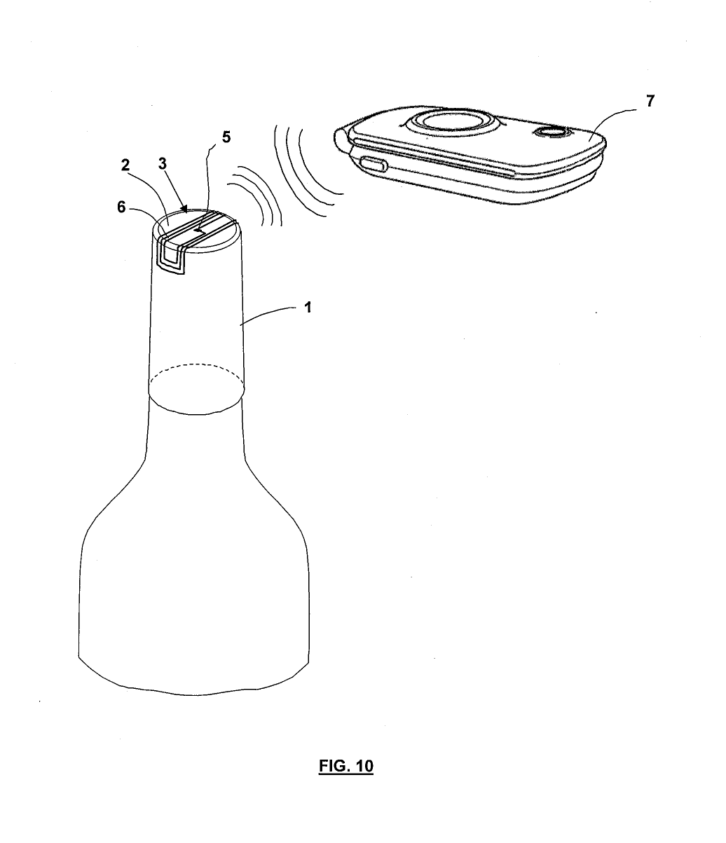

For the embodiments shown in FIGS. 6 to 10, said RFID tag 3 contains an antenna 6 (which can have different shapes and sizes) and an integrated (reading or reading-writing) circuit 5, which circuit comprises a memory forming part or entirely forming said storage means, and in which a single code (such as the reference indicated previously) or a series of information on the product can be stored.

For the purpose of increasing the distance for reading the identifying data stored in the RFID tag 3, especially if the mentioned antenna 6 is a microantenna or short-range antenna, for one embodiment at least part of the capsule forms an additional antenna suitable for amplifying the signal emitted by said antenna 6, there being no physical contact between the two antennas.

In the event of incorporating information on the product in the memory of the RFID tag 3, this information is directly accessed by reading said RFID tag 3 by means of an RFID reader, mobile telephone, PDA or the like 7, as mentioned above (see FIG. 10).

In the event that such tag only stores the mentioned reference or single code, said single code that the RFID tag 3 has is also read by means of an RFID reader, mobile telephone, PDA or the like 7, but for an embodiment, the latter automatically sends the single code, through GSM/GPRS/UMTS technology or another wireless communication system or through Internet for example, to a database associated to the aforementioned control system, which control system sends back to it the information corresponding to said single code, two types of communications therefore being used, a wireless communication between the RFID reader 7 and the RFID tag 3, and another not necessarily wireless communication between the reader 7 and the device comprising said database (the latter communication necessarily being two-way).

As indicated above, for an exemplary embodiment it is possible to write in the RFID tag 3, it is thus possible to directly introduce additional information required by the manufacturer in the memory of the integrated circuit 5.

For the case in which the RFID tag 3 only stores a reference, said additional information can be registered in said database, in this case it is not necessary to be able to write in the memory of the integrated circuit 5.

Said information or identifying data can contain data about the products, or other data for promotional or advertising, marketing purposes, etc., it is available in real time and allows identifying the product, informing the consumer (through the use of mobile telephones or other electronic devices which can communicate through a wireless route), protecting manufacturers and brands, managing, following and controlling the production and distribution of the products by the manufacturers. In other words, all the capabilities inherent to the use of RFID.

The use of a mobile telephone, PDA, or the like 7—a device with a great penetration and used daily worldwide—for reading and identifying bottles of beverages allows the final user to have a universal system facilitating an easy, reliable and safe recognition of the quality and authenticity of the product without depending on third parties and at the same time providing him or her with useful and valuable information about the products.

Said RFID tag, microchip or the like 3 allows recognizing the original products by means of a single and exclusive identification for each product.

The possibility of counterfeiting the RFID tag 3 is minimal due to the high technology and to the important economic cost involved in assembling a production plant.

The possibility of falsifying the information contained in the RFID tag 3 is minimal, due to the control of the numbered integrated circuits 5 which are manufactured and the possibility of encrypting the data.

The brands can be assured that the marketed volume on the market is the one that is duly authorized by means of controlling the integrated circuits 5 contained in the RFID tags 3.

There are different possibilities for placing the RFID tag 3 on the capsule.

In FIGS. 1 to 5, the RFID tag 3 is a separate element adhered to the capsule by means of an assembling process, for example, using a specific adhesive or glue. Another way to implement the RFID tag 3 in the capsule is integrating it during the capsule manufacturing process. FIGS. 6 to 8 show said RFID tag 3 integrated in the capsule with different types of antennas 6 (coil-type antenna, dipole-type antenna).

A new method for placing the RFID tag 3 on the capsule is applied to ensure a complete protection against a possible reuse of the RFID tag 3. Specifically, as can be seen in FIGS. 7 to 10, part of the tag 3 is arranged on (although it could also be under) the upper part 2 and part of it is arranged on (although it could also be under) the flap 1, such that when the capsule or part of it is cut or removed in order to open the bottle, the tag 3 or part of it is destroyed or works in an anomalous or irregular manner.

For a preferred embodiment, the integrated circuit 5 is placed in the central part of the upper surface 2 of the capsule, and part of the antenna 6 is placed on the central part of the upper surface 2 and extends on both sides on the flap 1 of the capsule. This is the case of the embodiments shown in FIGS. 7 to 10 (although only one side of the flap 1 is observed).

By means of such arrangement, when the upper part of the capsule is removed to access the cap, or the cork in the case of wine, by means of cutting the part of the capsule covering the end of the bottle neck, either directly or according to several pre-cuts arranged for the purpose of making the removal of the capsule easier, a cut also occurs with the subsequent breaking of the antenna 6, as can be seen in FIG. 9. Said cut in the antenna 6 makes it useless and prevents reading the RFID tag 3.

Also in the case of wine, when the cork is removed from the bottles without removing the upper part of the capsule, the RFID tag 3 is perforated with the corkscrew, destroying the integrated circuit 5 placed at the center of the upper part 2 of the capsule or cutting the antenna 6, thus destroying the connection between the integrated circuit 5 and the antenna 6. Said cuts or erosions will prevent any later reading of the RFID tag 3. For this case, it is obviously not necessary for the antenna 6 to extend along the flap 1 of the capsule, i.e. an arrangement such as the one shown in FIG. 5, in which both the antenna 6 and the integrated circuit 5 are placed on the upper part 2, would be sufficient.

A person skilled in the art could introduce changes and modifications in the described embodiments without departing from the scope of the invention as it is defined in the attached claims.

1. A capsule for bottles for use with a wireless security or control system, comprising:
a device adapted for being detected through a wireless route by one or more sensors, located within a coverage range, said sensor or sensors forming part of said security or control system and associated with a database for at least one of managing, tracking and/or controlling production and distribution of said bottles;
said device comprising:
storage means for storing at least one of identification data and/or information data and is adapted to allow at least their reading, also through said wireless route, by said sensor or sensors of said security system and/or of said control system by further sensors that are independent of said security system and/or of said control system,
means for coupling said device to at least a portion of said capsule; and
insulation means disposed between said device and said portion of said capsule, said insulation means adapted reduce at least a portion of a magnetic interference on the device by said capsule.

2. A capsule for bottles according to claim 1, wherein said wireless route allowing said detection and/or said wireless route allowing said reading are set up by means of radiofrequency.

3. A capsule according to claim 1, wherein said device is a laminar element.

4. A capsule according to claim 3, wherein said laminar element is a radiofrequency identification tag or RFID tag.

5. (canceled)

6. (canceled)

7. (canceled)

8. A capsule for bottles according to claim 1, further comprising a flap wrapping the bottle neck and an upper part covering an end of the bottle neck.

9. A capsule for bottles according to claim 8, wherein said device is placed at least one of on an outer part of the capsule on said flap and/or on said upper part of the capsule.

10. A capsule for bottles according to claim 8, wherein said device is placed at least one of in an inner part of the capsule under the flap and/or under the upper part of the capsule.

11. (canceled)

12. (canceled)

13. A capsule for bottles according to claim 1, wherein said insulation means comprises a film covering at least part of the capsule, said film made of an insulating material adapted to counter-act magnetic interferences.

14. A capsule for bottles according claim 13, wherein the device comprises an antenna and an integrated circuit, and said storage means comprises a memory forming part of said integrated circuit.

15. A capsule for bottles according to claim 14, wherein said integrated circuit and/or said antenna are integrated in the capsule.

16. A capsule for bottles according to claim 15, wherein at least part of the capsule forms an additional antenna adapted to amplify a signal emitted by said antennae, to increase the distance for reading the identification and/or information data stored in the device.

17. A capsule for bottles according to claim 8, wherein at least part of the device is arranged on or under said upper part and part of it is arranged on or under said flap, such that when the capsule or part of it is cut or removed in order to open the bottle, said device or part of it either is destroyed or works in an anomalous or irregular manner.

18. A capsule for bottles according to claim 17 wherein at least the antenna is placed on a central part of the upper surface and extends on both sides on the flap of the capsule.

19. A capsule for bottles according to claim 18, wherein the integrated circuit is also placed in the central part of the upper surface of the capsule.

20. A capsule for bottles according to claim 1, wherein said sensors are adapted to read the identification and/or information data of the device are or form part of at least one of the group selected from: a wireless reader, a mobile telephone and a personal digital assistant or PDA with an integrated or external, reading or reading and writing RFID module.

21. A capsule for bottles according to claim 1, wherein said device is adapted to allow writing data in said storage means, also through said wireless route.

22. A capsule for bottles according to claim 1, wherein said device is passive.

23. A capsule for bottles according to claim 1, wherein said device is active.

24. A bottle for detection by a wireless system and adapted to contain an alcoholic beverage or liquor, said bottle comprising:
a capsule comprising:
a device adapted for being wirelessly detected by one or more sensors located within a predetermined coverage area, said one or more sensors forming part of said wireless system, said wireless system for at least one of managing, tracking and/or controlling production and distribution of said bottles;
said device comprising:
storage means for storing at least one of identification data and/or information data, said storage means adapted to allow at least the reading of said data by at least one of i) said one or more sensors of said wireless system and/or ii) by further sensors that are independent of said wireless system,
means for coupling said device to at least a portion of said capsule; and
insulation means disposed between said device and said portion of said capsule, said insulation means adapted counteract at least a portion of a magnetic interference on the device created by said capsule.
